(19) United States
(12) Patent Application Publication
(10) Pub. No.: US 2014/0270884 A1
(43) Pub. Date: Sep. 18, 2014

(54) Thermal Transfer and Dye Sublimation Ribbons Utilizing Plasma Treatment to Replace Back Coat

(71) Applicant: ILLINOIS TOOL WORKS INC., Glenview, IL (US)

(72) Inventors: James R. Landry, Maple Park, IL (US); John H. Schneider, Frankfort, IL (US); William A. Herring, Valpariso, IN (US)

(21) Appl. No.: 13/841,924

(22) Filed: Mar. 15, 2013

(51) Int. Cl. B41J 31/00

(52) U.S. Cl. CPC B41J 31/00
USPC 400/241; 347/45

(57) ABSTRACT

A method providing for the replacement of the traditional back coat of thermal transfer ribbons or dye sublimation ribbons uses a plasma treatment to chemically modify the print head side surface of a PET substrate of the ribbons. The chemically modified surface of the PET substrate provides the necessary heat resistance and coefficient of friction to allow the thermal print head to function properly without burn-through of the PET carrier film and without sticking to the thermal print head. Accordingly, plasma treated thermal transfer ribbons or dye sublimation ribbons can be made without a back coat.

### TECHNICAL FIELD

The exemplary teachings herein pertain to ribbons or dye-sheets used for printing on a substrate, and to methods and techniques of making these ribbons or dye-sheets. Specifically, the present disclosure relates to a method and use of a plasma treatment to replace the traditional back coat of these ribbons or dye-sheets, and to the products made by the methods and techniques.

### BACKGROUND

Plasma treatment of various surfaces for various purposes is generally known. Further, there are different types of plasma treatments. Air or atmospheric plasma treatment is a surface modification technique that uses a low temperature corona discharge, generated by the application of high voltage to sharp electrode tips, to impart changes in the properties of a surface. If the atmosphere at the point of discharge is simply air (mainly nitrogen & oxygen), the process is generally termed corona treatment. Flame plasma treatment involves the use of burning flammable gas to modify a surface through the distribution electrons in an oxidation form. Chemical plasma treatment is a surface modification technique that involves depositing various chemical groups onto a surface to modify its properties and/or characteristics. This process is often conducted in a vacuum chamber where the air has been removed and gases or vapors are introduced into the discharge area. In most cases these methods are employed to alter the surface of a plastic film or part to increase the surface energy of the surface being treated for enhanced wet out and adhesion of subsequent printing or wet coatings to be applied to that surface (i.e., packaging films, painted parts, etc.).

Two common printing methods utilize thermal transfer ribbons (TTR) and dye diffusion thermal transfer (D2T2) ribbons (also known as dye-sublimation or dye-sub ribbons or dye-sheets) as is known in the art. In use, a thermal print head heats the ink layer on the TTR or the dye panels on the dye-sub ribbons, to transfer the ink from the TTR onto or to diffuse the dye from the dye panels into the substrate, respectively. The ink layer on the TTR and the dye panels on the dye-sub ribbon are carried by or attached to a thin polyester (PET or other filmic) carrier in a suitable manner known in the art. Back coats are typically applied to the print head side of thermal transfer and dye sublimation ribbons. They are applied directly to the PET or other filmic carrier. They typically have a low coefficient of friction and provide or impart added heat resistance to the PET or other filmic carrier. These properties prevent burn-through of the PET or other filmic carrier and prevent the film from sticking to the thermal print heads, thus increasing the life of these print heads in the field.

A typical YMCKO dye-sheet or dye-sub ribbon is illustrated in FIG. 1. As can be seen in FIG. 1, five panels are affixed to the PET or other filmic carrier, the last two removably affixed via a sub coat. These five panels in order are a yellow dye panel (Y), a magenta dye panel (M), a cyan dye panel (C), a black pigmented resin panel (K) and a clear mass transfer panel which can be used as a protective overlay (O), hence the acronym YMCKO. Each of these panels is of the same size as the substrate being printed on, e.g., an ID/identification card, transaction card or the like.

During D2T2 printing, the dye-sheet or ribbon is indexed over the card substrate being printed on such that each of the five panels is positioned over the card substrate in succession. As is known in the art, a computer controlled thermal print head selectively heats each of the panels in the desired locations (individual pixels) determined by a computer image program or file to produce a colored image on the card substrate.

The back coat on the PET or other filmic carrier of the dye-sheet or ribbon aids in the transport across the thermal print head, and transfers heat from the thermal print head through to the dye-coats. When the yellow, magenta and cyan panels are heated, in turn, the respective colored dye is diffused from the panels at the locations at which the heat is applied to produce the respective colored dots on the card substrate to form the image according to the computer image program. The panels comprise a polymer and the dye, which when heated causes the dye to diffuse onto the card substrate, while the polymer remains attached to the PET or other filmic carrier of the dye-sheet or ribbon.

The black pigmented panel is attached to the PET or other filmic carrier via, a sub coat, which allows the black panel, comprising a polymer and a black pigmented resin, to be transferred to the card substrate at the locations where heat is applied. Thus, unlike the yellow, magenta and cyan panels, both the polymer and the black pigmented resin of the black panel are transferred to the card substrate where heated. Similarly, the clear mass transfer panel or protective overlay (O) is completely transferred from the dye-sheet or ribbon and onto the card substrate where heated, typically over the entire card substrate.

Similarly, a standard TTR is illustrated in FIG. 2. As can be seen in FIG. 2, an ink layer is affixed via an optional release coat to a PET or other filmic carrier. An optional size layer is applied to the ink layer. During TTR printing, the TTR is registered over the substrate to be printed on, e.g., an ID/identification card. A thermal print head selectively heats the ink layer in the desired locations determined by a computer image program or file to produce an image on the card substrate. A back coat on the PET or other filmic carrier of the TTR aids in the transport across the thermal print head, and transfers heat from the thermal print head through to the ink layer. When the ink layer is heated, the ink is transferred to the card substrate at the locations where the heat is applied to produce the image on the card substrate according to the computer image program.

Due to the fact that back coats are applied to the side of the PET or other filmic carrier opposite of the thermal transfer layers, often special equipment is needed to apply the back coat, or the PET or other filmic carrier must pass through an extra coating pass during the manufacture of the thermal transfer and dye sublimation ribbons.

Therefore, a need exists for an improved method of making TTR and dye-sub ribbons, which is directed toward overcoming these and other disadvantages of prior art methods. Accordingly, to address the above stated issues, an improved method to provide heat resistance and a lower coefficient of friction to the print head side of the PET or other filmic carrier of a TTR or dye-sub ribbons, while providing ease of manufacturing and cost savings, is needed. The exemplary teachings herein fulfill such a need. It is desired that the methods and techniques for providing the above benefits be applicable to any instances or applications wherein a back coat for a printing process or similar process is needed.

### SUMMARY

The exemplary technique(s), system(s) and method(s) presented herein provide for the replacement or elimination of the back coat of a TTR or dye-sub ribbon, through the use of a chemical plasma treatment applied to the PET or other filmic carrier of the TTR or dye-sub ribbon. The plasma treatment chemically modifies the print head side of the PET or other filmic carrier such that the traditional back coat is not necessary. The chemically modified surface of the PET or other filmic carrier provides the necessary heat resistance and coefficient of friction to allow the thermal print head to function properly without burn-through of the PET or other filmic carrier and without sticking to the thermal print head. The plasma treatment of the PET surface thus eliminates the need for the back coat, for any special equipment used to apply the back coat, and for any extra coating pass during the manufacturing process.

Additional objects, advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accordance with the present teachings, by way of example only, not by way of limitation. In the drawing figures, like reference numerals refer to the same or similar elements.

FIG. 1 is a schematic cross-sectional illustration of a prior art, typical YMCKO dye-sheet or ribbon;

FIG. 2 is a schematic cross-sectional illustration of a prior art TTR;

FIG. 3 is a schematic cross-sectional illustration of an exemplary embodiment of a D2T2 dye-sheet or ribbon having been plasma treated according to the present disclosure; and

FIG. 4 is a schematic cross-sectional illustration of an exemplary embodiment of a TTR having been plasma treated according to the present disclosure.

### DETAILED DESCRIPTION

The following description refers to numerous specific details which are set forth by way of examples to provide a thorough understanding of the relevant teachings. It should be apparent to those skilled in the art that the present teachings may be practiced without such details. In other instances, well known methods, procedures, and components have been described at a relatively high-level, without detail, in order to avoid unnecessarily obscuring aspects of the present teachings.

Referring now to FIG. 3, a D2T2 dye-sheet or ribbon incorporating the teachings of the present disclosure is illustrated. Specifically, the D2T2 dye-sheet or ribbon of the present disclosure includes five panels attached to a PET or other filmic carrier. The five panels illustrated are, in order, a yellow dye panel (Y), a magenta dye panel (M), a cyan dye panel (C), and a black pigmented resin panel (K) and a clear mass transfer panel which can be used as a protective overlay (O).

On the print head side of the PET or other filmic carrier, the surface of PET or other filmic carrier has been chemically modified by a plasma treatment, as illustrated schematically by the row of dots in FIG. 3. Accordingly, when a computer controlled thermal print head selectively heats each of the panels, in turn, in the desired locations as determined by a computer program to produce a colored image on the card substrate, the chemically modified surface of the PET or other filmic carrier provides the necessary heat resistance and coefficient of friction to allow the thermal print head to function properly without burn-through of the PET or other filmic carrier and without sticking to the thermal print head, without the need for the traditional back coat.

Similarly, a TTR incorporating the teachings of the present disclosure is illustrated in FIG. 4. As can be seen in FIG. 4, an ink layer is affixed via an optional release coat to a PET or other filmic carrier. An optional size layer is applied to the ink layer. On the print head side of the PET or other filmic carrier, the surface of PET or other filmic carrier has been chemically modified by a plasma treatment, as illustrated schematically by the row of dots in FIG. 4.

Accordingly, when a computer controlled thermal print head selectively heats the ink layer in the desired locations as determined by a computer program to produce a colored image on the card substrate, the chemically modified surface of the PET or other filmic carrier provides the necessary heat resistance and coefficient of friction to allow the thermal print head to function properly without burn-through of the PET or other filmic carrier and without sticking to the thermal print head, without the need for the traditional back coat.

Most of the gases and vapors that can and have been introduced into the corona discharge region of a plasma treater will increase the surface energy of the continuous web (plastic or paper carrier) or part for enhanced wet out and adhesion. The many gases used include oxygen, argon, carbon dioxide, acetylene, other hydrocarbon-based gases, ammonia and other nitrogen containing gases. In order to reduce the surface energy of a surface via plasma one must use less conventional gaseous & vapor species that will form radicals and deliver chemistries onto the surface of the carrier or part that will impart release and heat resistant characteristics. These materials would include chemistries involving fluorinated materials, silicones, methylsiloxanes, olefinics and the like. Some of these items may already exist in a gaseous phase at room temperature, while others may require pre-heating to yield the vapor form of the liquid species in order to convey it into the corona/plasma discharge area.

Utilizing plasma treatment to chemically modify the print head side surface of the PET or other filmic carrier can lower the cost of the ribbons by eliminating the need for: the back coat, the use of one coating station, any needed drying equipment for the back coat, and any subsequent evaporation of solvents or water used to apply the back coat. In addition, instead of using a coating station to apply a back coat, that coating station can now be used elsewhere in the printing process, for example to coat additional functional layers to the substrate being printed. Examples include: increased abrasion resistance, surface or other color effects, etc.

While the foregoing discussion presents the teachings in an exemplary fashion with respect to the disclosed methods and techniques for plasma treating TTR and dye-sub ribbons to replace the traditional back coat, and the products produced by the methods and techniques, it will be apparent to those skilled in the art that the teachings may apply to the plasma treatment of any type of substrate which has traditionally required a back coat. Further, while the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

What is claimed is:

1. A thermal transfer ribbon comprising:
at least one pigmented ink or coating layer;
a filmic carrier for carrying the at least one ink or coating layer, wherein the filmic carrier has a print head side surface; and
a plasma treatment applied to the print head side surface.

2. The thermal transfer ribbon of claim 1, wherein the plasma treatment chemically modifies the print head side surface of the filmic carrier to impart heat resistance and a low coefficient of friction.

3. The thermal transfer ribbon of claim 2, wherein the plasma treatment eliminates the need for a back coat on the print head side surface of the filmic carrier.

4. A D2T2 ribbon comprising:
a plurality of print panels;
a filmic carrier for conveying the plurality of print panels, wherein the filmic carrier has a print head side surface; and
a plasma treatment applied to the print head side surface.

5. The D2T2 ribbon of claim 4, wherein the plasma treatment chemically modifies the print head side surface of the filmic carrier to impart heat resistance and a low coefficient of friction.

6. The D2T2 ribbon of claim 5, wherein the plasma treatment eliminates the need for a back coat on the print head side surface of the filmic carrier.

7. A process of producing a thermal transfer ribbon without a back coat, comprising the step of:
plasma treating a print head side surface of a filmic carrier to impart heat resistance and a low coefficient of friction suitable to allow a thermal print head to function properly without a need for a back coat.

8. The product made by the process of claim 7.

9. A process of producing a D2T2 ribbon without a back coat, comprising the step of:
plasma treating a print head side surface of a filmic carrier to impart heat resistance and a low coefficient of friction suitable to allow a thermal print head to function properly without a need for a back coat.

10. The product made by the process of claim 9.
